(19) United States
(12) Patent Application Publication
(10) Pub. No.: US 2013/0227388 A1
(43) Pub. Date: Aug. 29, 2013

(54) Persistent Storage of Profile Data for Script Compilation

(71) Applicants: Paul Trunley, Bellevue, WA (US); Ivan D. Pashov, Woodinville, WA (US); M. David Fields, JR., Kirkland, WA (US); Edward J. Praitis, Woodinville, WA (US); Jonathan A. Silvera, Seattle, WA (US)

(72) Inventors: Paul Trunley, Bellevue, WA (US); Ivan D. Pashov, Woodinville, WA (US); M. David Fields, JR., Kirkland, WA (US); Edward J. Praitis, Woodinville, WA (US); Jonathan A. Silvera, Seattle, WA (US)

(73) Assignee: MICROSOFT CORPORATION, Redmond, WA (US)

(21) Appl. No.: 13/406,798

(22) Filed: Feb. 28, 2012

(51) Int. Cl. G06F 17/00

(52) U.S. Cl. 715/234

(57) ABSTRACT

A client application, such as an HTTP client, stores script profile data associated with JavaScript compilation as metadata in a cache, such as an HTTP indexed cache, for a given entry. Accessing the indexed data can be performed much faster without incurring additional disk input/output operations, thus facilitating compilation activities. In addition, an identifier such as the script URL can be used to efficiently enable compilation across websites that commonly utilize the same JavaScript.

### BACKGROUND

Just in Time (JIT) compilation is a method to improve runtime performance of computer programs. JIT compilers continuously translate code as it is needed to improve performance and reduce performance degradation. For example, JavaScript JIT compilation can rely on script profile data to optimize script compilation/translation time and execution time. The profile data for JavaScript is not used across sessions because the additional overhead to store and retrieve the data from disk, would negate the CPU savings obtained by JIT compilation. Additionally, the profile data is not reused when the same script is encountered in a different webpage.

### SUMMARY

This Summary is provided to introduce a selection of concepts in a simplified form that are further described below in the Detailed Description. This Summary is not intended to identify key features or essential features of the claimed subject matter.

In one or more embodiments, a client application, such as an HTTP client, stores script profile data associated with JavaScript compilation as metadata in a cache, such as an HTTP indexed cache, for a given entry. Accessing the indexed data can be performed much faster without incurring additional disk input/output operations, thus facilitating compilation activities. In addition, an identifier such as the script URL can be used to efficiently enable compilation across websites that commonly utilize the same JavaScript.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 is a flow diagram that describes steps in a method in accordance with one or more embodiments.

FIG. 3 illustrates an example system that includes the computing device as described with reference to FIG. 1.

FIG. 4 illustrates various components of an example device that can be implemented as any type of computing device as described herein.

### DETAILED DESCRIPTION

### Overview

In one or more embodiments, a client application, such as an HTTP client, stores script profile data associated with JavaScript compilation as metadata in a cache, such as an HTTP indexed cache, for a given entry. Accessing the indexed data can be performed much faster without incurring additional disk input/output operations, thus facilitating compilation activities. In addition, an identifier such as the script URL can be used to efficiently enable compilation across websites that commonly utilize the same JavaScript.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

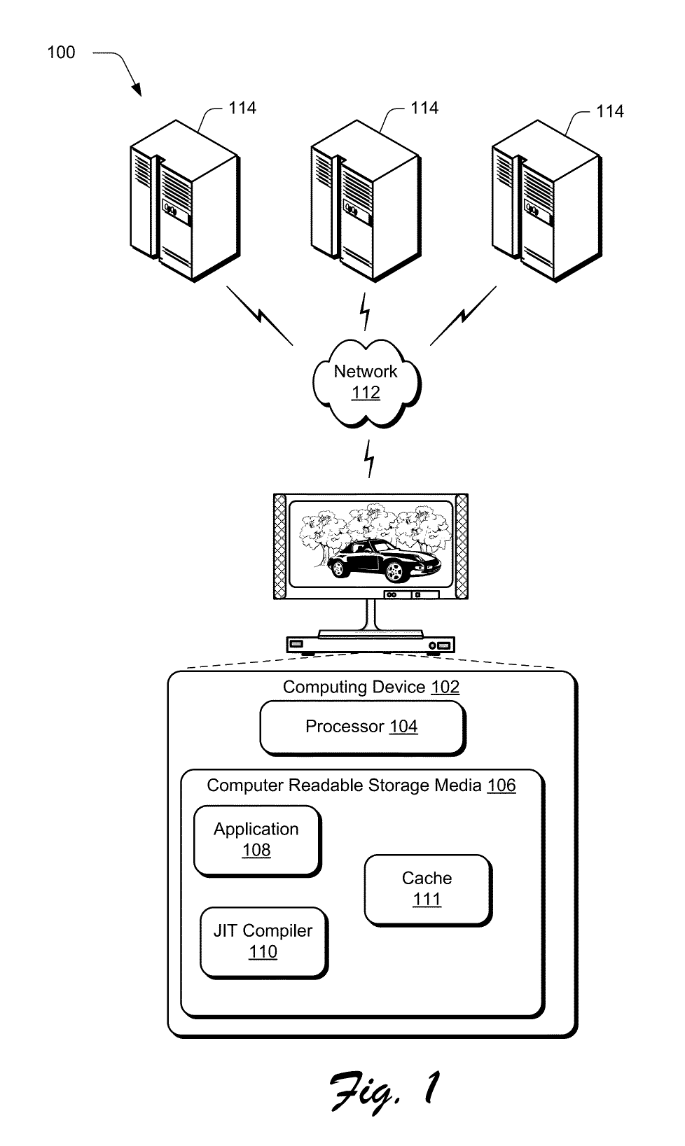

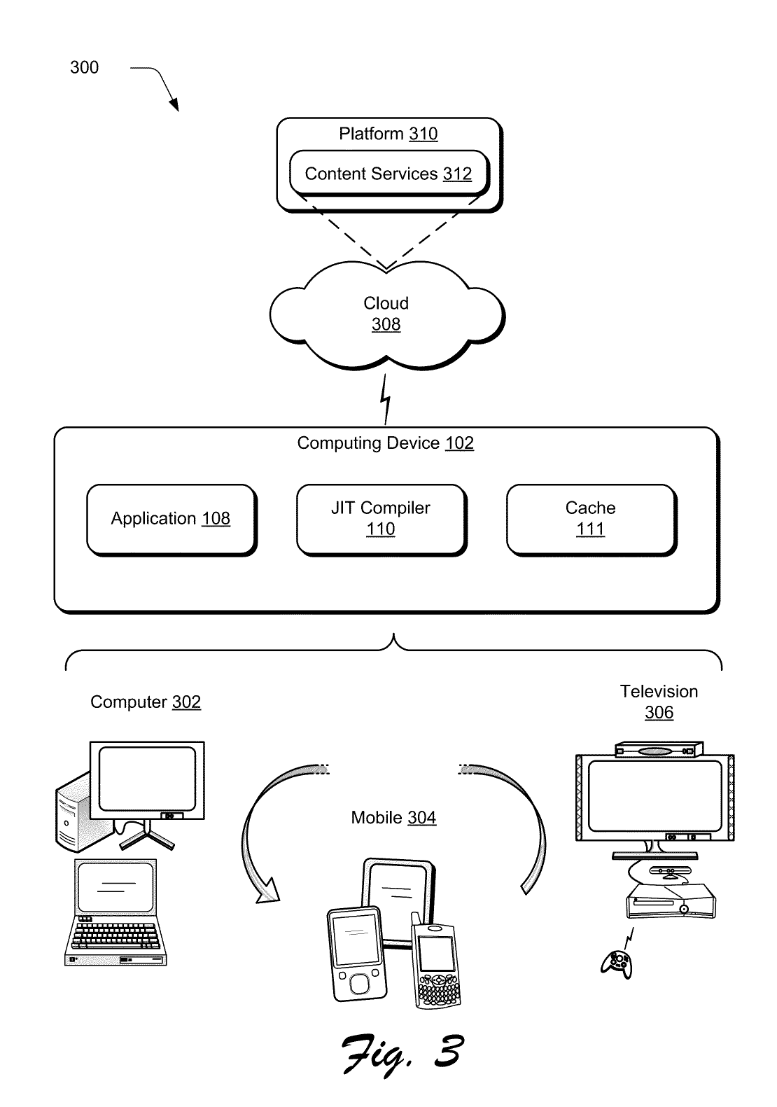

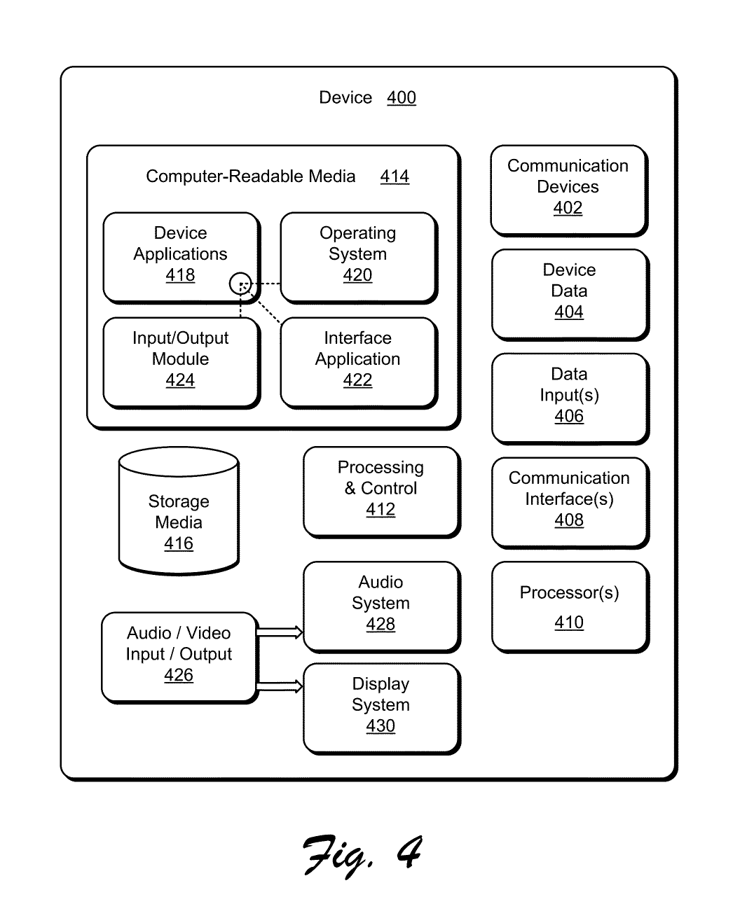

FIG. 1 illustrates an operating environment in accordance with one or more embodiments, generally at 100. Environment 100 includes a computing device 102 in the form of a local client machine having one or more processors 104, one or more computer-readable storage media 106, one or more applications 108 that resides on the computer-readable storage media and which are executable by the processor 104. Computing device 102 also includes a JIT compiler 110 and a cache 111 that operate as described below. Computing device 102 can be embodied as any suitable computing device such as, by way of example and not limitation, a desktop computer, a portable computer, a handheld computer such as a personal digital assistant (PDA), mobile phone, television, tablet computer, and the like. One of a variety of different examples of a computing device 102 is shown and described below in FIGS. 3 and 4.

Applications 108 can include any suitable type of applications including, by way of example and not limitation, a web browser. The web browser is configured to navigate via the network 112. Although the network 112 is illustrated as the Internet, the network may assume a wide variety of configurations. For example, the network 112 may include a wide area network (WAN), a local area network (LAN), a wireless network, a public telephone network, an intranet, and so on. Further, although a single network 112 is shown, the network 112 may be configured to include multiple networks.

The browser, for instance, may be configured to navigate via the network 112 to interact with content available from one or more web servers 114 as well as communicate data to the one or more web servers 114, e.g., perform downloads and uploads. The web servers 114 may be configured to provide one or more services that are accessible via the network 112. Examples of such services include email, web pages, photo sharing sites, social networks, content sharing services, media streaming services, and so on.

One or more of the applications 108 may also be configured to access the network 112, e.g., directly themselves and/or through the browser (in the event an application 108 is not a web browser). For example, one or more of the applications 108 may be configured to communicate messages, such as email, instant messages, and so on. In additional examples, an application 108, for instance, may be configured to access a social network, obtain weather updates, interact with a bookstore service implemented by one or more of the web servers 114, support word processing, provide spreadsheet functionality, support creation and output of presentations, and so on.

Thus, applications 108 may also be configured for a variety of functionality that may involve direct or indirect network 112 access. For instance, the applications 108 may include configuration settings and other data that may be leveraged locally by the application 108 as well as synchronized with applications that are executed on another computing device. In this way, these settings may be shared by the devices. A variety of other instances are also contemplated. Thus, the computing device 102 may interact with content in a variety of ways from a variety of different sources.

In operation, when a user visits a website using, for example, an application 108 in the form of a web browser, and retrieves a web page, there are typically a number of different resources that are utilized to render the web page. One or more of these resources can be JavaScript. The browser will process the web page and check to see if the script has been downloaded before and cached in cache 111. If so, the JavaScript and associated profile data is retrieved from the cache and JIT Compiler 110 can compile it using any profile data that might have been previously cached during a previous compilation to assist in the current compilation. Examples of profile data are provided below. If the JavaScript has not been previously cached, then the JIT Compiler 110 will compile the JavaScript and, during its compilation and subsequent execution, will collect profile data associated with the JavaScript and cache it, along with the JavaScript, in the cache 111 for future use. Accessing the profile data when indexed in the cache 111 can be performed much faster than performing separate disk input/output operations, thus facilitating subsequent compilation activities which can be executed faster. In addition, an identifier such as the script URL can be used to efficiently enable compilation across websites that utilize the same JavaScript. That is, if another website utilizes the same JavaScript, by identifying the URL associated with the JavaScript, the previously-cached JavaScript and its associated profile data can be retrieved from the cache 111 and utilized during the compilation process, as described in more detail below.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware or virtual machines of the computing device 102 to perform operations, e.g., processors, functional blocks, and so on. For example, the computing device 102 may include a computer-readable medium that may be configured to maintain instructions that cause the computing device, and more particularly the operating system and associated hardware of the computing device 102 to perform operations. Thus, the instructions function to configure the operating system and associated hardware to perform the operations and in this way result in transformation of the operating system and associated hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having described an example environment in which the techniques described herein may operate, consider now a discussion of some example embodiments that can utilize the principles described herein.

### Example Embodiments

Caching and persisting profile data associated with JavaScript compilation collected at runtime during execution of the script can allow its reuse to improve performance during subsequent executions of the same script as part of the same web page or a different web page. Using this profile data to determine whether to defer parsing or parsing the script improves application load times and, in turn, enhances the user's experience as perceived from their interaction with a particular web page. As some use examples, consider the following.

Bob navigates to his banking site using his desktop browser. When the website's JavaScript is compiled during Bob's interaction with it, the JIT Compiler 110 generates profile data including profile data based on his usage patterns on the banking site and eventually caches this profile data in cache 111. The next time Bob goes to his banking site using his browser, the compiler retrieves the cached JavaScript and profile data to generate better, more efficiently compiled code that leads to the site loading and executing faster. Additionally, as the JavaScript is compiled faster, Bob experiences a faster process.

Jane owns a slate form factor device that can be plugged into a desktop keyboard and monitor. She visits a shopping site using her desktop browser when her computer is docked to her monitor and keyboard and, separately, using a browser on her slate device when she is using her slate remotely. Due to her different input methods for the desktop browser and the slate's browser, she has different usage patterns on the same website. Her desktop browser and slate browser cause separate profile data to be saved into the cache, thus ensuring the shopping site loads and runs fast when she uses both the desktop browser and the slate browser.

In one or more embodiments, during compilation and execution, the JIT Compiler 110 can collect a wide range of classes of profile information or data, from data about which functions are executed to type hints for individual variables. A wide range of classes of profile information is cached in order to enable efficient machine code to be JIT compiled directly using cached profile data, without waiting for additional interpreted iterations.

In the illustrated and described embodiment, and by way of example and not limitation, the following profile data can be collected and cached. It is to be appreciated and understood, however, that other profile data can be collected and cached without departing from the spirit and scope of the claimed subject matter.

| Type of Data | Description |
|---|---|
| Function usage | Data that describes whether a function |
| | is utilized at all. |
| Function call frequency | How frequently a function is called. |
| | This can include measures of the |
| | number of interpreted iterations, as well |
| | as call counts during execution in JIT |
| | compiled code. |
| Target function(s) of call sites | Which function or functions are called |
| | from a given site. When call pass |
| | profile collection is implemented, |
| | profile data can be cached pertaining to |
| | entire code paths, including spanning |
| | multiple functions, for call sites. |
| Type hints for variables | Int and float type hints for parameters, |
| | local variables, field accesses, array |
| | access and call site return values: a) int |
| | only, b) int or float only, c) observed a |
| | non-int or non-float value, and d) no |
| | data. |
| Presence of implicit calls | These flags describe whether a given |
| | function or loop contains implicit calls |
| | (such as property getters or setters, |
| | valueOf, toString, etc.). This can also |
| | include implicit call bit for each load |
| | field. |
| Array and element type | For every array access, the kind of array |
| | is recorded (e.g., JS array, typed array, |
| | or object). For JS arrays, a type hint is |
| | recorded for its elements. |
| Function de-optimization hints | Data for de-optimization hints for |
| | functions for which aggressive |
| | optimization yields frequent bailouts. |

Having considered examples of profile data that can be collected and used to compile JavaScript in a more efficient manner, consider now an example method that can be utilized in accordance with one or more embodiments.

Example Method

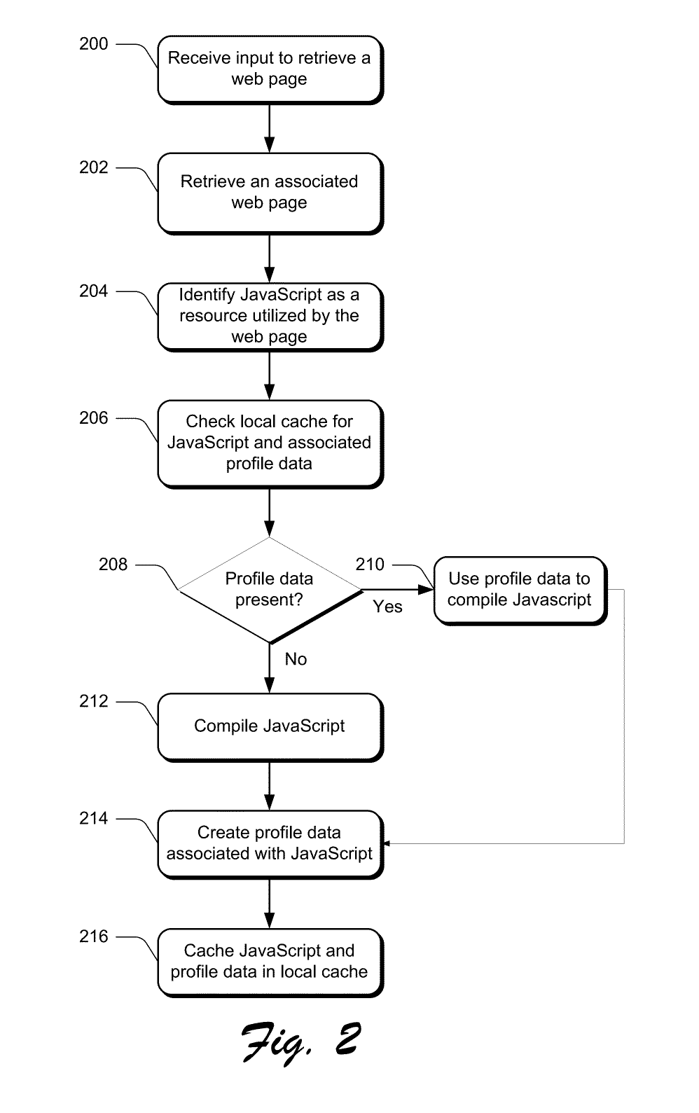

FIG. 2 is a flow diagram that describes steps in a method in accordance with one or more embodiments. The method can be implemented in connection with any suitable hardware, software, firmware, or combination thereof. In at least some embodiments, the method is implemented in software that resides on some form of computer readable storage medium. Example software that can implement the following method includes a web browser and a suitably-configured compiler such as JIT compiler 110 described above.

Step 200 receives input to retrieve a web page. This step can be performed in any suitable way such as, by way of example and not limitation, receiving user input by way of a browser or other suitably-configured application. Responsive to receiving the input, step 200 to retrieves an associated webpage. In the illustrated and described embodiment, the retrieved webpage includes markup that describes resources that are to be utilized to render the webpage. One of these resources, as noted above, can comprise script, such as JavaScript, VBScript, and the like. Step 204 identifies script, such as JavaScript, as a resource that is utilized by the webpage. This step can be performed in any suitable way. For example, in at least some embodiments, this step can be performed by identifying a resource identifier, such as the URL, that is associated with the JavaScript and is to be used to download the JavaScript. Before attempting to download the JavaScript, step 206 checks a local cache for the JavaScript and any associated profile data that might be stored in the local cache. Examples of profile data are provided above. In at least some embodiments, the local cache is implemented as an HTTP cache in which other information associated with the webpage may be cached. This makes the retrieval process more efficient because, rather than using separate databases, the HTTP cache is still being accessed for other browser operations. This check can be performed by using the resource identifier or URL as an index into the cache. If step 208 ascertains that profile data is present in the local cache, step 210 uses the profile data to compile the JavaScript. The method can then branch to step 214 to create updated profile data associated with the JavaScript which may or may not then be cached. For example, if the profile data is largely the same, step 216 need not be performed. It is to be appreciated and understood that the profile data can be created during interpretation, compilation and execution.

If, on the other hand, profile data associated with the JavaScript is not found in the local cache, step 212 compiles the JavaScript. Step 214 creates profile data associated with the JavaScript. This step can be performed in any suitable way, examples of which are provided above. Step 216 caches the JavaScript and the profile data in the local cache. This step can be performed by using the JavaScript's resource identifier or URL as an index to the JavaScript and its associated profile data.

In this manner, previously-compiled JavaScript can be more efficiently compiled and utilized in subsequent browsing sessions that retrieve the same webpage or a different webpage that utilizes the same JavaScript. In addition, the techniques described above can be utilized to provide profile data that is tailored depending on the user's device and interaction pattern.

Having considered an example method in accordance with one or more embodiments, consider now an example system and device that can be utilized to implement the embodiments described above.

Example System and Device

FIG. 3 illustrates an example system 300 that includes the computing device 102 as described with reference to FIG. 1. The example system 300 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 300, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 302, mobile 304, and television 306 uses. Each of these configurations includes devices that may have generally different constructs and capabilities, and thus the computing device 102 may be configured according to one or more of the different device classes. For instance, the computing device 102 may be implemented as the computer 302 class of a device that includes a personal computer, desktop computer, a multi-screen computer, laptop computer, netbook, and so on. Each of these different configurations may employ the techniques described herein, as illustrated through inclusion of the application 108, JIT compiler 110, and cache 111.

The computing device 102 may also be implemented as the mobile 304 class of device that includes mobile devices, such as a mobile phone, portable music player, portable gaming device, a tablet computer, a multi-screen computer, and so on. The computing device 102 may also be implemented as the television 306 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 308 includes and/or is representative of a platform 310 for content services 312. The platform 310 abstracts underlying functionality of hardware (e.g., servers) and software resources of the cloud 308. The content services 312 may include applications and/or data that can be utilized while computer processing is executed on servers that are remote from the computing device 102. Content services 312 can be provided as a service over the Internet and/or through a subscriber network, such as a cellular or Wi-Fi network.

The platform 310 may abstract resources and functions to connect the computing device 102 with other computing devices. The platform 310 may also serve to abstract scaling of resources to provide a corresponding level of scale to encountered demand for the content services 312 that are implemented via the platform 310. Accordingly, in an interconnected device embodiment, implementation of functionality described herein may be distributed throughout the system 300. For example, the functionality may be implemented in part on the computing device 102 as well as via the platform 310 that abstracts the functionality of the cloud 308.

FIG. 4 illustrates various components of an example device 400 that can be implemented as any type of computing device as described with reference to FIGS. 1 and 3 to implement embodiments of the techniques described herein. Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments of the techniques described herein. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the device data 404, as well as various device applications 418 and any other types of information and/or data related to operational aspects of device 400. For example, an operating system 420 can be maintained as a computer application with the computer-readable media 414 and executed on processors 410. The device applications 418 can include a device manager (e.g., a control application, software application, signal processing and control module, code that is native to a particular device, a hardware abstraction layer for a particular device, etc.). The device applications 418 also include any system components or modules to implement embodiments of the techniques described herein. In this example, the device applications 418 include an interface application 422 and an input/output module 424 that are shown as software modules and/or computer applications. The input/output module 424 is representative of software that is used to provide an interface with a device configured to capture inputs, such as a touchscreen, track pad, camera, microphone, and so on. Alternatively or in addition, the interface application 422 and the input/output module 424 can be implemented as hardware, software, firmware, or any combination thereof. Additionally, the input/output module 424 may be configured to support multiple input devices, such as separate devices to capture visual and audio inputs, respectively.

Device 400 also includes an audio and/or video input-output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 428 and/or the display system 430 are implemented as external components to device 400. Alternatively, the audio system 428 and/or the display system 430 are implemented as integrated components of example device 400.

### CONCLUSION

In one or more embodiments, a client application, such as an HTTP client, stores script profile data associated with JavaScript compilation as metadata in a cache, such as an HTTP indexed cache, for a given entry. Accessing the indexed data can be performed much faster without incurring additional disk input/output operations, thus facilitating compilation activities. In addition, an identifier such as the script URL can be used to efficiently enable compilation across websites that commonly utilize the same JavaScript.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method comprising:
identifying, for a retrieved webpage, script as a resource that is utilized by the webpage;
before attempting to download the script, checking a local cache for the script and any associated script profile data;
responsive to ascertaining that script profile data is present in the local cache, using the script profile data to compile the script.

2. The method of claim 1, wherein said identifying is performed by identifying a resource identifier associated with JavaScript.

3. The method of claim 1, wherein said identifying is performed by identifying a URL associated with JavaScript.

4. The method of claim 1, wherein the local cache comprises an HTTP cache in which other information associated with the webpage may be cached.

5. The method of claim 1, wherein said checking is performed by using a URL associated with JavaScript profile data.

6. The method of claim 1, wherein the profile data comprises JavaScript profile data associated with function usage.

7. The method of claim 1, wherein the profile data comprises JavaScript profile data associated with function call frequency.

8. The method of claim 1, wherein the profile data comprises JavaScript profile data associated with type hints for variables.

9. The method of claim 1, wherein the profile data comprises different classes of JavaScript profile data including: function usage, function call frequency, target function of call sites, type hints for variables, presence of implicit calls, array and element type, or function de-optimization hints.

10. One or more computer-readable storage media embodying computer readable instructions, which, when executed, implement a method comprising:
identifying, for a retrieved webpage, JavaScript as a resource that is utilized by the webpage;
before attempting to download the JavaScript, checking a local cache for the JavaScript and any associated JavaScript profile data;
responsive to ascertaining that JavaScript profile data is not present in the local cache, compiling the JavaScript;
creating JavaScript profile data associated with the JavaScript; and
caching the JavaScript and the JavaScript profile data in the local cache effective to enable JavaScript compilation in subsequent sessions that retrieve the same webpage or a different webpage that utilizes the same JavaScript.

11. The one or more computer-readable storage media of claim 10, wherein said creating comprises creating JavaScript profile data that is tailored to a device or a user's interaction pattern.

12. The one or more computer-readable storage media of claim 10, wherein said checking is performed by using a URL associated with the JavaScript profile data.

13. The one or more computer-readable storage media of claim 10, wherein the JavaScript profile data comprises data associated with function usage.

14. The one or more computer-readable storage media of claim 10, wherein the JavaScript profile data comprises data associated with function call frequency.

15. The one or more computer-readable storage media of claim 10, wherein the JavaScript profile data comprises data associated with type hints for variables.

16. The one or more computer-readable storage media of claim 10, wherein the JavaScript profile data comprises different classes of profile data including: function usage, function call frequency, target function of call sites, type hints for variables, presence of implicit calls, array and element type, or function de-optimization hints.

17. A system comprising:
one or more computer readable storage media;
computer-readable instructions embodied on the one or more computer readable storage media which, when executed, implement a system comprising a JIT compiler configured to:
identify, for a retrieved webpage, JavaScript as a resource that is utilized by the webpage;
before attempting to download the JavaScript, check a local HTTP cache for the JavaScript and any associated JavaScript profile data;
responsive to ascertaining that JavaScript profile data is present in the local HTTP cache, use the JavaScript profile data to compile the JavaScript; and
responsive to ascertaining that the JavaScript profile data is not present in the local HTTP cache:
compile the JavaScript;
create JavaScript profile data associated with the JavaScript; and
cache the JavaScript and the JavaScript profile data in the local HTTP cache effective to enable JavaScript compilation in subsequent sessions that retrieve the same webpage or a different webpage that utilizes the same JavaScript.

18. The system of claim 17, wherein the JIT compiler is configured to create JavaScript profile data that is tailored to a device or a user's interaction pattern.

19. The system of claim 17, wherein the JavaScript profile data comprises data associated with function usage.

20. The system of claim 17, wherein the JavaScript profile data comprises different classes of profile data including: function usage, function call frequency, target function of call sites, type hints for variables, presence of implicit calls, array and element type, or function de-optimization hints.
